(19) United States
(12) Patent Application Publication
(10) Pub. No.: US 2026/0355610 A1
(43) Pub. Date: Nov. 12, 2026

(54) VEHICLE FOR ONE RIDER, HAVING A BALL ROLLING ON THE GROUND

(71) Applicant: Innovated Transport Systems UG, Essen (DE)

(72) Inventor: Ulrich Sambeth, Essen (DE)

(21) Appl. No.: 19/128,625

(22) PCT Filed: Nov. 10, 2023
(86) PCT No.: PCT/EP2023/081438

§ 371 Date: Oct. 1, 2025

(30) Foreign Application Priority Data
Nov. 11, 2022 (DE) 10 2022 129 853.1

(51) Int. Cl. A63C 17/24; A63C 17/01; A63C 17/04; A63C 17/12; B62K 11/00

(52) U.S. Cl. CPC A63C 17/24; A63C 17/011; A63C 17/014; A63C 17/12; B62K 11/007

(57) ABSTRACT

A vehicle for the movement of one rider, having a ball rolling on a ground, a carrying element supported on the ball, on which carrying element the rider stands when the vehicle is in operation, and a drive arrangement which is supported on the carrying element and drives the ball. The vehicle is additionally supported via a roller rolling on the ground.

### CROSS REFERENCE TO RELATED APPLICATION

The present application claims the priority benefits of International Patent Application No. PCT/EP2023/081438, filed Nov. 10, 2023, and claims the benefit of German patent application DE 10 2022 129 853.1, filed Nov. 11, 2022.

### BACKGROUND AND FIELD OF THE INVENTION

The invention relates to a vehicle for the locomotion of a rider, having a ball rolling on the ground, having a carrying element supported on the ball, on which carrying element the rider stands during operation of the vehicle, having a drive arrangement which is supported on the carrying element and which drives the ball.

A vehicle for locomotion of a rider, in particular a skateboard-like ball scooter, is already known from European patent EP 3 043 877 B1. The vehicle is in contact with the ground during operation exclusively via a ball rolling on the ground and consists substantially of the ball, a carrying element supported on the ball and having two stand-on surfaces, one for each foot of the rider, a drive arrangement and a controller. In one embodiment, the drive arrangement is essentially built up from a total of four omni-wheels, three of which are combined into a group and roll on the upper half of the ball, and the fourth of which rolls along an equator of the ball. All the omni-wheels stand in each case without an angle of tilt on the surface of the ball so that when the carrying element is orientated horizontally the respective axes of rotation of the three omni-wheels of the group are horizontal and the axis of rotation of the fourth omni-wheel is orientated vertically. The carrying element is predominantly supported on the ball via the group of three omni-wheels. With the aid of the fourth omni-wheel, the carrying element can be rotated about a vertical axis of the ball. The ball can therefore roll in all directions on the ground below or in the carrying element which is located at an equator of the ball. In addition to the support function, all the omni-wheels assume a driving function. For this purpose, the omni-wheels are each driven via electric motors and upstream transmissions which are mounted on the carrying element. In order to use the vehicle, which can also be referred to as a sports device, leisure device or fun device, the rider stands in a freely balancing manner on the carrying element and controls, brakes and steers the vehicle by shifting his weight. The rider is assisted therein by the controller which comprises, inter alia, a balance control module which assists the rider in balancing the carrying element into a horizontal position. The direction of movement of the vehicle and therefore the rolling direction of the ball is controlled via the inclination of the carrying element, which is induced by the shifting of the rider's weight. The measured acceleration data and angle data of the carrying element are processed in the controller, based thereon it is determined which of the motors of the respective omni-wheels are to be driven, and a desired travel movement and the balance position are achieved with the required direction of rotation and rotational speed. The vehicle is fitted with three rechargeable batteries for the motors and the controller, which batteries are disposed on the lower side of the carrying element around the ball.

Furthermore, a further skateboard-like ball scooter for one rider is known from the British laid-open document GB 2 407 780 A. In this case also, the ball scooter essentially consists of a ball rolling on the ground and a carrying element supported on the ball and having two stand-on surfaces, one for each foot of the rider. The carrying element is rectangular in shape, like a skateboard. In a typical forwards travel direction, the carrying element is oriented in its longitudinal direction and the rider stands with one foot in front of the ball and one foot behind the ball and is thus standing sideways on the carrying element. The ball scooter is driven, for example, by the rider in a scooter-like manner and the ball is consequently drive-less. In addition, a sliding element, a roller or a steering roller are arranged in each case in the region of the four corners of the carrying element. The rider can steer the ball scooter by lowering one of the two rear edges during travel so that the sliding element, the roller or the steering roller comes into contact with the ground. In so doing, the ball scooter is braked on one side and steering movement is initiated. A skateboard-like and non-driven ball scooter comparable thereto is known from European laid-open document EP 0 985 435 A1. Instead of the sliding elements, rollers or steering rollers arranged in each of the four corners of the carrying element, only a single ball is arranged at the rear on the carrying element. The single ball for steering the ball scooter is not in contact with the ground when the carrying element is in the horizontal position.

### SUMMARY OF THE INVENTION

The present invention provides an improved compact vehicle for the locomotion of a rider, having a ball rolling on the ground.

In accordance with the invention, an improved vehicle for the locomotion of a rider, having a ball rolling on the ground, having a carrying element supported on the ball, on which carrying element the rider stands during operation of the vehicle, having a drive arrangement which is supported on the carrying element and which drives the ball is provided by virtue of the fact that the vehicle is additionally supported by a roller rolling on the ground. As rolling elements, the vehicle uses only a ball and a roller, wherein the steering is effected by virtue of the fact that the ball can be driven transverse to the travel direction.

In an advantageous manner, the vehicle can be steered via the driven ball.

In a particularly advantageous manner, the roller is dragged by the driven ball via the carrying element. Overall, provision is thus made that the ball is driven and the roller is drive-less or not driven, like a vehicle having front wheel drive. The roller is thus dragged by the ball during operation. Overall, the vehicle is comparable to a scooter which has a driven front ball, which can be steered by the drive, and a dragged rear roller. During normal operation of the vehicle, the ball and roller are thus both in contact with the ground.

Stable travel behaviour in the forwards travel direction is achieved by virtue of the fact that the roller is arranged behind the ball, as seen in the forwards travel direction of the vehicle, and is arranged at a spaced disposition from the ball.

In an advantageous manner, provision is made that the carrying element has a front stand-on part for a first foot of the rider and a rear stand-on part for a second foot of the rider, as seen in the forwards travel direction of the vehicle.

Direct steering behaviour is achieved by virtue of the fact that the ball is arranged between the front stand-on part and the rear stand-on part, as seen in the forwards travel direction of the vehicle.

Indirect steering behaviour is achieved by virtue of the fact that the ball is arranged in front of the front stand-on part and in front of the rear stand-on part, as seen in the forwards travel direction of the vehicle.

In a preferred embodiment, provision is made that the front stand-on part is arranged above the ball and the ball is arranged in front of the rear stand-on part, as seen in the forwards travel direction of the vehicle. In relation to this feature, “above” means that the front stand-on part is arranged at least partially above the ball, as seen in a plan view of the vehicle. Preferably, the front stand-on part is arranged completely within the contour of the ball and in particular centrally above the ball, as seen in the plan view of the vehicle.

In order to allow the rider to be balanced on the vehicle, the roller is designed such that the vehicle can be inclined to the right and left, as seen in the forwards travel direction. For this purpose, the roller can be narrow or round.

In a particularly advantageous manner, provision is made that the vehicle can be steered by the rider inclining the vehicle, in that a controller evaluates the inclination and the drive arrangement drives the ball in a desired travel direction. The vehicle is steered exclusively via the feet of the rider freely balancing on the carrying element. By shifting his weight, the rider initiates the steering of the vehicle. The controller thus reacts to the change in a lateral angle of inclination of the carrying element and, via the drive arrangement, drives the ball to roll in the desired lateral direction. The lateral angle of inclination is in a range of 0 degrees to +/−15 degrees or preferably to +/−10 degrees. Then, the controller compensates for the measured inclination of the carrying element so that it is located in a preferably horizontal orientation. The rider preferably simply stands on the carrying element in the region of the stand-on surfaces which are provided with anti-slip overlays so that the rider can stand firmly and safely and for better coordination of the shifting of weight. In an advantageous manner, provision is made for the controller to comprise a balance control module which assists a rider in balancing the carrying element in a horizontal position in space. This balancing of the carrying element in a balanced orientation is effected via corresponding actuation of the first and second omni-wheels. The degree of assistance can be varied and be set at such a high level that it is relatively easy for the rider to balance on the carrying element. On the other hand, the level of assistance is not so great that the rider is prevented, by shifting his weight, from effecting steering of the vehicle in the direction of inclination by reason of the weight-shift.

In a variant, provision is made that the roller is formed such that the vehicle is stabilised to the right and left, as seen in the forwards travel direction. Therefore, the rider does not have to balance freely and steers the vehicle via corresponding control elements.

In a particularly advantageous and simple manner, the vehicle comprises only a single ball and/or only a single roller.

In a structurally-preferred manner, provision is made that the carrying element comprises a cover part, two stand-on parts and a carrying part, the cover part covers the upper part of the ball, and the lower part of the ball protrudes downwards out of the carrying part.

Effective driving of the ball is achieved by virtue of the fact that the ball is driven via two omni-wheels directly and without the interpositioning of a transmission, in each case via an electric motor and each electric motor is fixed to the carrying element.

In a particularly advantageous manner, the electric motors are supplied with power via at least one rechargeable battery.

Optimal travel behaviour of the vehicle without sudden or abrupt movements is achieved in that the carrying element is supported on the ball via a support arrangement, wherein the support arrangement comprises at least one non-driven omni-wheel.

In an advantageous manner, the vehicle has no handle and is steered by a rider standing on the carrying element in a freely balanced manner, without using a holding bar. Therefore, the rider can balance freely on the carrying element of the vehicle in the manner of riding a skateboard without supporting himself with his hands on a column or on a steering bar or sitting on a saddle or seat disposed on the carrying element.

In an alternative embodiment, the vehicle can comprise a steering device in order to provide the rider with a hold and to accommodate control elements for the desired travel directions.

The invention will be explained in more detail hereinunder with the aid of several exemplified embodiments illustrated in the drawings.

### BRIEF DESCRIPTION OF THE DRAWINGS

FIG. 1 shows a perspective view showing the principle of a vehicle in accordance with the invention for the locomotion of a rider, in a first embodiment;

FIG. 2 shows a perspective view of a rider carrying the vehicle;

FIG. 3 shows a perspective view of the vehicle of FIG. 1 without a rider;

FIG. 4 shows a perspective view of the vehicle of FIG. 3 with a transparent carrying element;

FIG. 5 shows a perspective view showing the principle of a vehicle in accordance with the invention for the locomotion of a rider, in a second embodiment;

FIG. 6 shows a perspective view of the vehicle of FIG. 5 without a rider;

FIG. 7 shows a perspective view showing the principle of a vehicle in accordance with the invention for the locomotion of a rider, in a third embodiment;

FIG. 8 shows a further perspective view showing the principle of the vehicle of FIG. 7; and

FIG. 9 shows a simplified diagram of the controller of the vehicle.

### DETAILED DESCRIPTION OF THE PREFERRED EMBODIMENTS

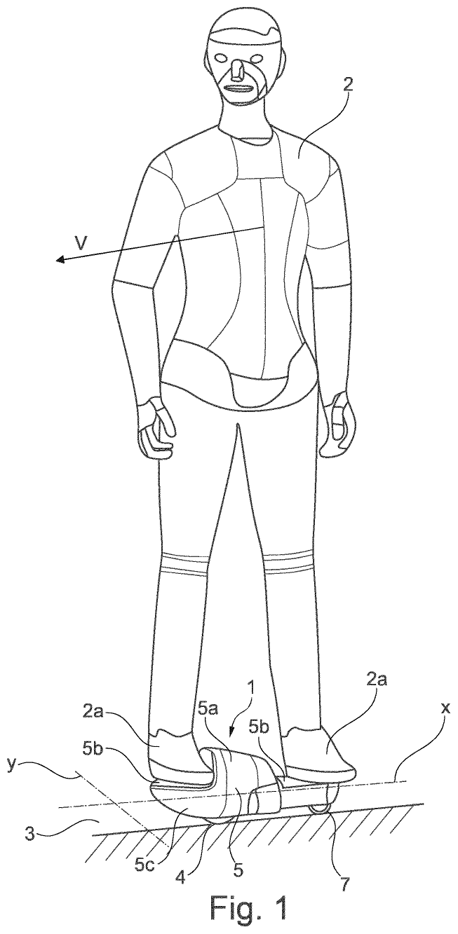

FIG. 1 illustrates a perspective view showing the principle of a vehicle 1 in accordance with the invention, in particular of a skateboard-like ball scooter, for the locomotion of a rider 2, in a first embodiment. The vehicle 1 substantially consists of a single ball 4 rolling on the ground 3, a single roller 7 rolling on the ground 3, a carrying element 5 supported on the ball 4 and the roller 7, and a drive arrangement 6, not shown in FIG. 1, for the ball 4 with a controller 20. The ball 4 is arranged on the carrying element 5 at a spaced disposition from the roller 7 and in front of the roller 7, as seen in the direction of a longitudinal axis x of the vehicle 1 and in a forwards travel direction V of the vehicle 1. Moreover, the roller 7 is mounted on the carrying element 5 so as to be rotatable about a transverse axis y. The transverse axis y is perpendicular to the longitudinal axis x and is oriented horizontally when the carrying element 5 is also oriented horizontally. Moreover, the roller 7 has a round or circular segment-shaped running surface which is oriented on the diameter of the ball 4, i.e. has the same curvature. Furthermore, the contact points or contact lines or contact surfaces of the ball 4 and the roller 7 on the ground 3 lie one behind another on the longitudinal axis x of the vehicle 1. The ball 4 has a diameter in the range of 50 mm to 270 mm, preferably in the range of 75 mm to 150 mm, particularly preferably of 100 mm, and the roller 7 has a diameter in the range of 20 mm to 100 mm, preferably in the range of 35 mm to 75 mm, particularly preferably 70 mm. The width of the roller 7 is in the range of 10 mm to 150 mm, preferably 10 mm to 30 mm, particularly preferably 10 mm. It is feasible to use rollers which are known from in-line skates and have a diameter of 70 mm and a width of 10 mm and consist of PU material. The carrying element 5 has a length is in the range of 500 mm to 1000 mm, preferably 500 mm to 800 mm, particularly preferably 600 mm. A front region of the ball 4 is at a spaced disposition of 30 mm to 100 mm from a front end of the carrying element 5. The roller 7 can protrude as far as a rear end of the carrying element 5. A wheel base in relation to a roller axle 7a of the roller 7 and a virtual axis of rotation of the ball 4 during forwards travel is at least at 300 mm, in order to achieve stable travel behaviour of the vehicle 1 and has an upper limit dictated by the dimensions of the roller 7 and ball 4 as well as the length of the carrying element 5.

Since the vehicle 1 rests on the ground 3 only via the single ball 4 and the single roller 7, it can tilt about the longitudinal axis x laterally to the right and left. The rider 2 is thus balanced in relation to the longitudinal axis x on the vehicle 1 during travel. The rider 1 is assisted therein by the controller 20 which comprises, inter alia, a balance control module 18a, 18b having corresponding electronic stability programmes, which assists the rider 2 in balancing the carrying element 5 about the longitudinal axis x in a horizontal position. Moreover, the ball 4 and the roller 7 partially protrude downwards out of the carrying element 5.

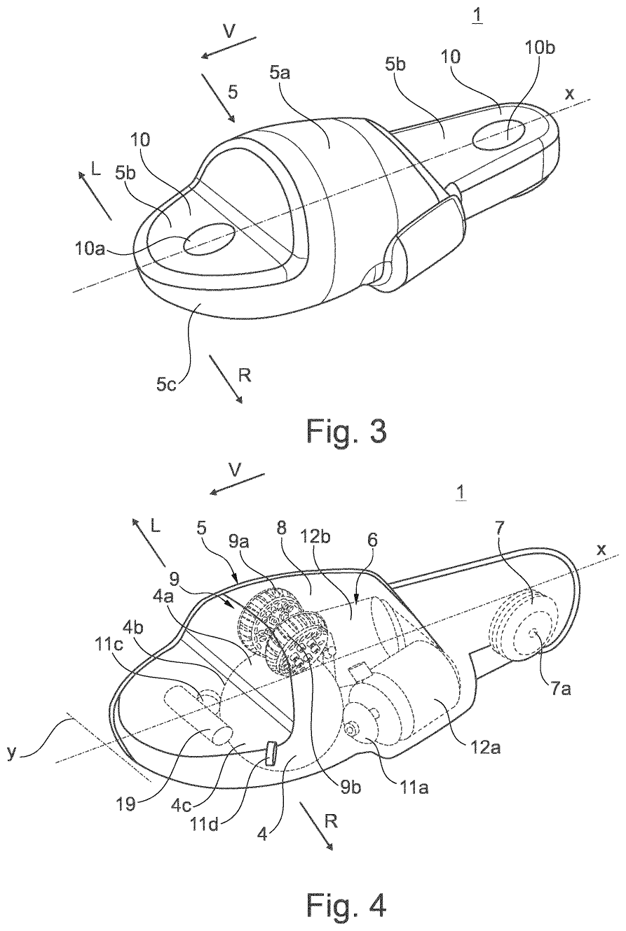

The use of the driven ball 4 as wheel replacement has the advantage that the vehicle 1 can be driven on the ground 3 in any desired directions and can thus also be steered by means of the ball 4. In the present case, the vehicle 1 is driven via the ball 4 in a left travel direction L, a right travel direction R and a forwards travel direction V (see FIGS. 3 and 4).

The vehicle 1 can also be referred to as a sports device, leisure device or fun device, on which the rider 2 stands during use in a freely balancing manner on the carrying element 5 as on a skateboard and in which the rider 2 steers the vehicle 1 by shifting his weight. The vehicle 1 can also be braked, accelerated and moved via the rider 2 shifting his weight or via a remote control to be operated by the rider 2. The rider 2 shifting his weight to the front and back is sufficient to generate control pulses via first and second sensors 10a, 10b in stand-on surfaces 10 of the carrying element 5. Moreover, in this first embodiment and the second embodiment which will be described hereinafter the vehicle 1 does not have a handle for the rider 2. Therefore, the rider 2 has no assistance means available to him, such as a steering bar, a column for support or a seat for sitting on, or as an aid to balancing. Therefore, the rider 2 must balance freely on the carrying element 5 of the vehicle 1 without supporting himself with his hands on a column or on a steering bar or with his shins on a knee board or sitting on a saddle or seat disposed on the carrying element 5.

The carrying element 5 is a complex component with a plurality of functions and for this purpose comprises a cover part 5a, two stand-on parts 5b and a lower carrying part 5c. An upper part 4a of the ball 4 (see FIG. 4) is covered by the cover part 5a which therefore protects the rider 2 from contact with the rotating ball 4, and the cover part 5a surrounds an installation space 8 (see FIG. 4) between a surface 4b of the ball and an inner side of the cover part 5a (see FIG. 4).

Stand-on parts 5b disposed in an opposing manner with respect to the ball 4 adjoin a lower edge of the cover part 5a. The two stand-on parts 5b protrude, as front and rear projections, outwards away from the cover part 5a and to the front and rear in the forwards travel direction V and form stand-on surfaces 10, which are substantially planar or horizontal as seen when the vehicle 1 is a horizontal balance position, for a right and left foot 2a of the rider 2 (see also FIG. 3). In this substantially lateral balance position of the vehicle 1, the ball 4 and the roller 7 are on the ground 3.

The stand-on surfaces 10 are disposed in front of and behind the ball 4, as seen in a forwards travel direction V of the vehicle 1. The forwards travel direction V is based on a travel direction of the vehicle 1 in the direction of its longitudinal axis x, wherein the ball 4 is located in front of the roller 7. In the forwards travel direction V, the driver 2 moves sidewards.

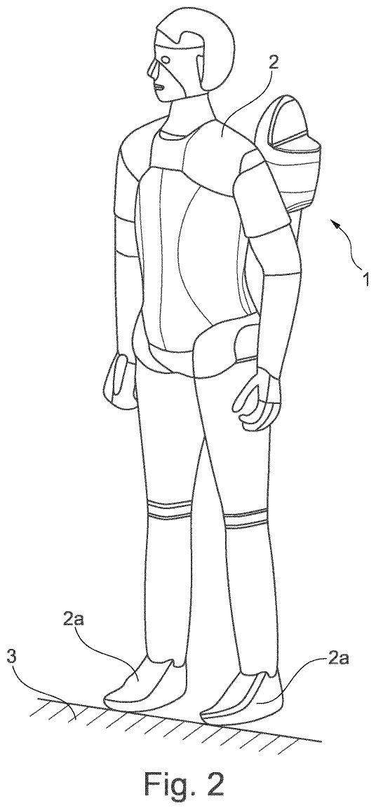

FIG. 2 shows a perspective view of a rider 2 who is carrying the vehicle 1 on his back e.g. via a shoulder carrying strap, not shown. The overall weight of the vehicle 1 is less than 5 kg, preferably in the range of 3 to 5 kg.

FIG. 3 shows a perspective view of the vehicle of FIG. 1 without the rider 2. The shape of the vehicle 1 and thus essentially the shape of the carrying element 5 resembles that of a sandal, in which the cover part 5a forms the strap, adjoined by a front, shorter and wide stand-on part 5b and a rear, longer and narrower stand-on part 5b, as seen in the direction of the longitudinal axis x. As seen in plan view, the carrying element 5 is trapezoidal in shape with rounded portions at the front and rear and tapering towards the rear. It is fundamentally also feasible for the carrying element 5, in particular the stand-on parts 5b, to be not only semi-circular and trapezoidal but also oval, rectangular or polygonal or of a combined geometric shape. However, the semi-circular or trapezoidal stand-on parts 5b have the advantage that the rider 2 has sufficient stability in spite of a material-saving design, and getting on and off the vehicle is facilitated by quickly and intuitively adopting a predetermined rider position. The stand-on parts 5b adjoin the cover part 5a on opposite sides in relation to the ball 4. The stand-on surface 10 for the front foot 2a is in front of the ball 4, as seen in the forwards travel direction V, and the stand-on surface 10 for the rear foot 2a is above the roller 7, also as seen in the forwards travel direction V.

The stand-on surfaces 10, shown in FIG. 3, for the right and left foot 2a of the rider 2 can be mere markings in the size of part of the feet 2a or can be regions on the stand-on parts 5b provided with an anti-slip coating or fitted with a slip-reducing layer. The size of the stand-on surfaces 10 is selected such that at least a central part of the feet 2a and the full width of the feet 2a are supported.

In a preferred embodiment, a first sensor 10a and a second sensor 10b are located in the region of the stand-on surfaces 10 for the right and left foot 2a respectively of the rider 2. These sensors 10a, 10b can be used to control the acceleration, movement and braking of the vehicle 1 by the rider 2. For this purpose, the sensors 10a, 10b can register for example changes in weight or gestures or sequences performed by the rider 2 with his feet 2a, and send a corresponding signal to the controller 20. In this way, the movement of the vehicle 1 in the forwards travel direction V is determined.

FIG. 4 illustrates a further perspective view of the vehicle 1 of FIG. 3, wherein the carrying element 5 is transparent in order to show the internal design of the vehicle 1, in particular its drive arrangement 6. As described above, the vehicle 1 rolls on the ground 3 via a combination of the ball 4 and [lacuna]. The roller 7 is mounted on the carrying element 5 via a roller axle 7a which is oriented in parallel with the transverse axis y. The ball 4 is inserted from beneath into a corresponding lower opening in the carrying part 5c and the carrying element 5 rests on top of the ball 4 by means of a support arrangement 9. The support arrangement 9 is located at the top in the region of the centre of the cover part 5a and includes two non-driven omni-wheels 9a, 9b which are each rotatable about its own axis of rotation, which axes are oriented in the direction of the transverse axis y. As seen in the direction of the longitudinal axis x, the omni-wheels 9a, 9b are arranged very close to each other but do not contact each other, on the right and left of the centre of the ball and in a V position with respect to each other. Alternatively, an embodiment of the support arrangement 9 with another type of ball mounting is also possible. The advantage is that the rolling of the ball 4 feels softer for the rider 2 and, by the avoidance of possible sudden or abrupt movements, wear on the two omni-wheels 9a, 9b is reduced. The omni-wheels 9a, 9b are mounted on the carrying element 5.

The drive arrangement 6 consists substantially of a first omni-wheel 11a, a second omni-wheel 11b, a third omni-wheel 11c and a fourth omni-wheel 11d which are distributed substantially uniformly around the periphery of the ball 4, preferably at the level of the equator 4c of the ball 4. The first omni-wheel 11a and the second omni-wheel 11b are spaced apart symmetrically on the right and left of the longitudinal axis x as seen in the direction of the longitudinal axis x and are each driven directly by a first motor 12a and a second motor 12b without the interpositioning of a transmission, said motors being supported on the carrying element 5. In FIG. 4, the second omni-wheel 11b is concealed by the ball 4. The omni-wheels 11a, 11b each preferably have the same diameter in the range of 20 mm to 300 mm, preferably in the range of 50 mm to 70 mm. The axes of the omni-wheels 11a, 11b are oriented so as to widen out forwards in a v-shape in relation to the longitudinal axis x. The non-driven omni-wheels 11c, 11d are smaller and each preferably have the same diameter in the range of 10 mm to 150 mm, preferably in the range of 20 mm to 40 mm.

The batteries 19 for the motors 12a, 12b and the controller 20 are arranged within the carrying part 5c and beneath the front stand-on part 5b and thus in front of the ball 4. Coordinated driving of the two omni-wheels 11a, 11b therefore leads to a movement of the vehicle 1 in the forwards travel direction V, in the right travel direction R or in the left travel direction L or in any intermediate direction thereof. A movement of the vehicle 1 in the forwards travel direction V is achieved, for example, in that the first and the second omni-wheels 11a and 11b are driven in a counter-rotating manner.

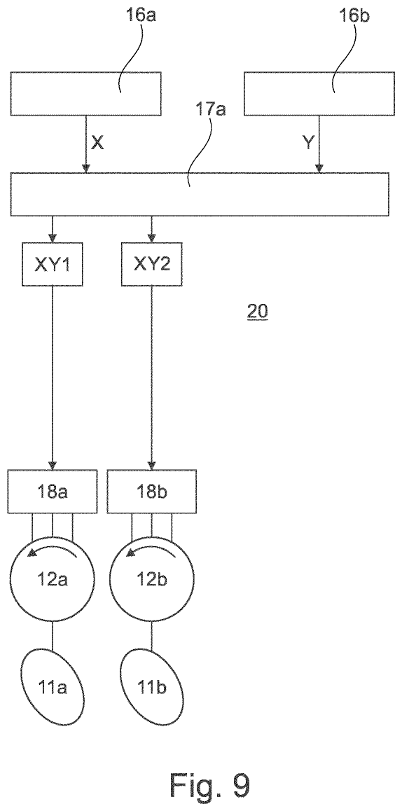

The motors 12a, 12b are attached to the carrying element 5 and are actuated via a controller 20 (see FIG. 9). 24V direct current motors with power levels in the range of 350 Watt to 800 Watt are used as the motors 12a, 12b, but use of brush-less three-phase AC motors in the range of 100 Watt to 500 Watt is also feasible.

For driving the ball 4, at least two driven omni-wheels 11a, 11b are required which drive the ball 4 preferably at 90 degree angles with respect to each other on the equator 4c. Theoretically, it is also possible to effect driving with three, four or more omni-wheels 11a, 11b, 11c, 11d. A design of the [lacuna] as omni-wheels 11a, 11b, 11c, 11d is possible, but is not required. Only when the ball 4 is driven above or below the equator 4c are omni-wheels required. Otherwise, the use of wheels or rollers as drive wheels instead of the omni-wheels 11a, 11b, 11c, 11d is possible.

It is self-evident that, between the surface 4b of the ball 4 and the inner side of the cover part 5a, a circumferential gap remains which permits free rotatability of the ball 4 relative to the carrying element 5. The vehicle 1 can also be provided with suspension in the region of the steering of the omni-wheels 9a, 9b, 11a, 11b, 11c, 11d or via an elastic ball. The ball 4 is preferably produced from hard plastics material. Bowling balls, for example, are suitable. Typically, the ball 4 is encapsulated with rubber or polyurethane. Furthermore, it can be seen that the omni-wheels 11a, 11b, 11c, 11d engage in the region of the equator 4c.

The omni-wheels 9a, 9b, 11a, 11b, 11c, 11d used are generally known and are also referred to as omni-directional wheels. In the case of the omni-wheels 9a, 9b, 11a, 11b, 11c, 11d, the running surface consists of a plurality of rollers arranged along the circumference, the axes of rotation of which are substantially orthogonal to the axis of rotation of the respective omni-wheel 9a, 9b, 11a, 11b, 11c, 11d and tangential to a circumference or a running surface of the omni-wheel 9a, 9b, 11a, 11b, 11c, 11d. The use of omni-wheels 9a, 9b, 11a, 11b, 11c, 11d makes it possible for the ball 4 to be able to rotate with low friction in not only the driving direction in relation to the respective omni-wheel 9a, 9b, 11a, 11b, 11c, 11d but in all other directions of the respective omni-wheel 9a, 9b, 11a, 11b, 11c, 11d.

In its additional function as a housing, the carrying element 5 protects the drive arrangement 6 against dirt and protects the feet 2a of the rider against possible contact with the rotating omni-wheels 9a, 9b, 11a, 11b, 11c, 11d and the motors 12a, 12b.

FIG. 4 also shows that the carrying part 5c of the carrying element 5 is rounded. The advantage of this rounded design is in an expanded inclination capability of the carrying element 5. However, alternatively other geometric designs are also feasible which, as required, limit the angle of inclination of the carrying element 5 by transitions from a rounded to an angular shape. The contours of the first and second motors 12a and 12b can be seen despite the covering carrying part 5c.

Overall, it should be stated with respect to the vehicle 1 that, just like a vehicle with front wheel drive, in this case the ball 4 is driven at the front and the roller 7 is non-driven at the rear. The roller 7 is thus dragged by the ball 4 during operation of the vehicle 1. Overall, the vehicle 1 is comparable to a scooter which has a driven front ball 4, which can be steered by the drive, and a dragged rear roller 7. During normal operation of the vehicle 1, the ball 4 and roller 7 are thus both in contact with the ground 3.

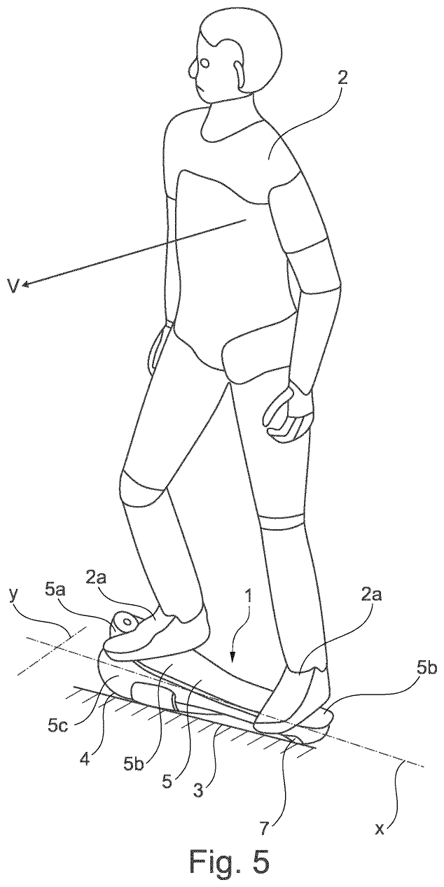

FIG. 5 shows a perspective view showing the principle of a vehicle 1 in accordance with the invention for the locomotion of a rider 2, in a second embodiment. This vehicle 1 functions just like the previously described first embodiment, except that the two feet 2a either stand behind the ball 4, as seen in the direction of the longitudinal axis x, or the front foot 2a stands above the ball 4 and the rear foot 2a stands behind the ball 4, as seen in the direction of the longitudinal axis x. In connection with the position of the front foot 2a above the ball 4, “above” is understood to mean that the front stand-on part 5a for the front foot 2a is arranged at least partially above the ball 4, as seen in plan view of the vehicle 1. Preferably, the front stand-on part 5a and thus the front foot 2a resting thereon are arranged completely within the contour of the ball 4 and in particular centrally above the ball 4, as seen in the plan view of the vehicle 1. Owing to the features in common with the first embodiment, reference is made to the description in relation to FIGS. 1 to 4 and the reference numerals used there are assumed hereinafter.

In the second embodiment also, balance is used to steer in the direction of the transverse axis y. Optionally, a steering device, not shown, can be attached to the vehicle 1. A corresponding connection bore is indicated on the top of the cover part 5a. In so doing, the vehicle 1 becomes a scooter, in particular a ball scooter.

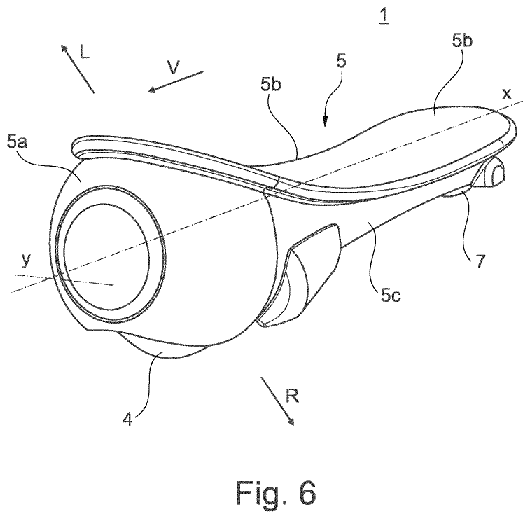

FIG. 6 illustrates a perspective view of the vehicle 1 of FIG. 5 without a rider 2. Owing to the features in common with the first embodiment, reference is again made to the description in relation to FIGS. 1 to 4 and the reference numerals used there. As previously described, only the arrangement of the stand-up parts 5b with respect to the ball 4 is selected to be different.

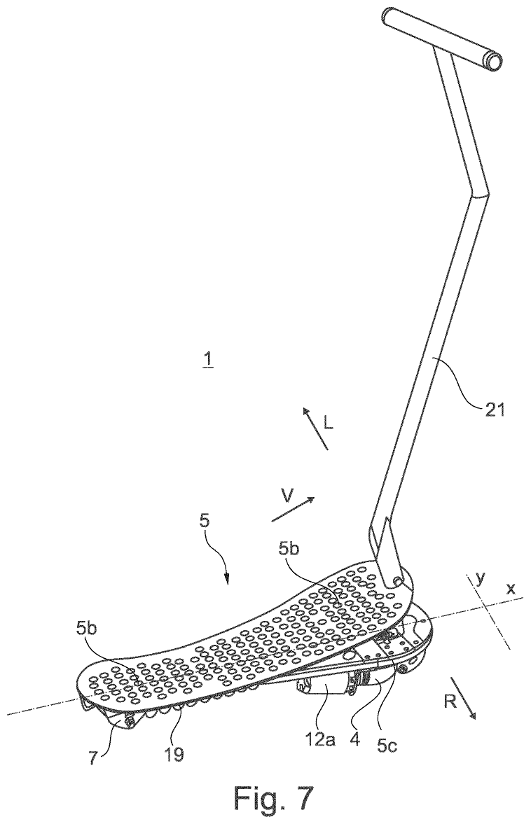

FIG. 7 shows a perspective view showing the principle of a vehicle 1 in accordance with the invention for the locomotion of a rider 2, in a third embodiment. This vehicle 1 functions just like the previously described first embodiment, except that either the two feet 2a stand behind the ball 4, as seen in the direction of the longitudinal axis x, or the front foot 2a stands above the ball 4 and the rear foot 2a stands behind the ball 4, as seen in the direction of the longitudinal axis x, and a steering device 21 is provided. Owing to the features in common with the first and second embodiments, reference is made to the description in relation to FIGS. 1 to 6 and the reference numerals used there are assumed hereinafter. A seat, not illustrated, for the rider 2 can also be provided. In that case, the seat is arranged on the carrying element 5. The vehicle 1 is controlled via the steering device 21 with corresponding switching elements or via a shift in weight to the right or left.

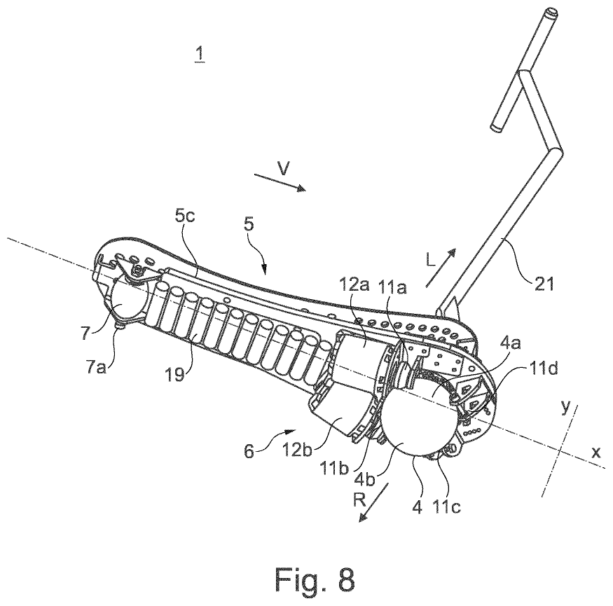

FIG. 8 shows a further perspective view showing the principle of the vehicle 1 of FIG. 7. In this case, the batteries 19 are arranged between the ball 4 and the roller 7 beneath the carrying part 5c.

FIG. 9 shows a simplified diagram of the controller 20 of the vehicle 1. The controller 20 is disposed on and/or within the carrying element 5. A plurality of components are integrated in the controller 20 in order to be able, on the basis of a balance position of the carrying element 5, to detect weight shifts of the rider 2 and therefore lateral rolling of the carrying element 5. The degree of rolling in the direction of the transverse axis y is detected by a roll gyroscope 16b. The gyroscope 16b supplies acceleration and angle data in each case. The roll gyroscope 16b detects the inclination movement about the longitudinal axis x. The lateral angle of inclination is in the range of 0 degrees to +/−15 degrees or preferably +/−10 degrees. A movement of the vehicle in the forwards travel direction V is controlled via a signal transducer 16a which receives for example signals from the first and second sensors 10a, 10b in the stand-on surfaces 10 of the carrying element 5 and thus from the feet 2a of the rider 2. The signal transducer 16a can also receive signals from a remote control, operated by the rider 2, or signals from the steering device or other control elements. The data detected by the roll gyroscope 16b and the signal transducer 16a are sent to an evaluation controller 17a. In dependence upon the detected degree of inclination and the direction of inclination and the signals in the forwards travel direction V, in the first evaluation controller 17a the motor or motors 12a, 12b to be driven are actuated as determined in each case via an electronic stability program 18a, 18b in the required direction of rotation and speed of rotation in order to produce the desired travel movement of the vehicle 1. At the same time, in parallel, via a balance control module within the evaluation controller 17a, the rider 2 is assisted in achieving the lateral balance position of the stand-on parts 5b of the carrying element 5, which are preferably orientated horizontally, by corresponding actuation of the motors 12a, 12b. The evaluation controller 17a is formed as a programmable microcomputer. The travel movement previously brought about by the rider 2 by the first shift in weight is maintained as long as the rider 2 maintains the inclination of the carrying element 5, and is suspended when the rider 2 shifts his weight in the opposite direction.

The above-mentioned roll gyroscope 16b is to be understood to be any type of measuring device with which the angular positions and angular directions can be determined in relation to the transverse axis y. These will conventionally be electronic circuits which operate with Piezo sensors.

Provision can be made that after both of the two sensors 10a, 10b have registered the presence of both feet 2a of the rider 2 and sent this to the evaluation controller 17a, the vehicle 2 is balanced by a balance control module disposed in the evaluation controller 17a so that the stand-on surfaces 10 of the carrying element 5 are brought into a horizontal position in space.

The previously described vehicles 1 can, instead of the round roller 7, comprise one wheel or two laterally spaced apart wheels, and so lateral stability of the vehicle 1 is achieved and thus balancing is eliminated. The vehicle 1 then has a three-point support on the ground 3. Steering of the vehicle 1 is then effected via a remote control, sensors with contact with the feet or switching elements on the steering device or brake pedal, acceleration pedal on the vehicle 1. In general, the vehicle 1 can be equipped with a brake.

In the previously described exemplified embodiments, first and second omni-wheels 9a, 9b of the support arrangement 9 and first to fourth omni-wheels 11a, 11b, 11c, 11d for driving and guiding the ball 4 have been described. These omni-wheels 9a, 9b, 11a, 11b, 11c, 11d are characterised by a high level of stability. Within the scope of the invention, it is certainly possible for the first and second omni-wheels 9a, 9b of the support arrangement 9 to be replaced by balls mounted in Teflon, and the first to fourth omni-wheels 11a, 11b, 11c, 11d to be replaced by normal rollers which must then engage in the equator 4c of the ball 4.

Of course, it is also feasible for the vehicle 1 to comprise a seat on the carrying element 5 in front of the roller 7 in the manner of a go-kart and for support surfaces 10 for the feet 2a to be arranged in the region of the ball 4, preferably on the right and left next to the ball 4.

1.-19. (canceled)

20. A vehicle for the locomotion of a rider, said vehicle comprising:
a ball rolling on the ground;
a carrying element supported on the ball;
a drive arrangement that is supported on the carrying element and which drives the ball;
wherein the vehicle can be steered via the driven ball and the vehicle has only a single ball and the vehicle is additionally supported by at least one roller which rolls on the ground and is drive-less;
wherein the rider stands on the carrying element during operation of the vehicle and the roller is dragged by the driven ball, as seen in a forwards travel direction of the vehicle; and
wherein the carrying element has a front stand-on part for a first foot of the rider and a rear stand-on part for a second foot of the rider, as seen in the forwards travel direction of the vehicle.

21. The vehicle as claimed in claim 20, wherein the roller is arranged behind the ball, as seen in a forwards travel direction of the vehicle, and is arranged at a spaced disposition from the ball.

22. The vehicle as claimed in claim 20, wherein the ball is arranged between the front stand-on part and the rear stand-on part, as seen in the forwards travel direction of the vehicle.

23. The vehicle as claimed in claim 20, wherein the ball is arranged in front of the front stand-on part and in front of the rear stand-on part, as seen in the forwards travel direction of the vehicle.

24. The vehicle as claimed in claim 20, wherein the front stand-on part is arranged above the ball and the ball is arranged in front of the rear stand-on part, as seen in the forwards travel direction of the vehicle.

25. The vehicle as claimed in claim 20, wherein the roller is arranged such that the vehicle can be inclined to the right and left, as seen in the forwards travel direction.

26. The vehicle as claimed in claim 25, wherein the vehicle can be steered by the rider inclining the vehicle, in that a controller evaluates the inclination and the drive arrangement drives the ball in a desired travel direction.

27. The vehicle as claimed in claim 20, wherein the roller is arranged such that the vehicle is stabilised to the right and left, as seen in the forwards travel direction.

28. The vehicle as claimed in claim 20, wherein the vehicle has only a single roller.

29. The vehicle as claimed in claim 20, wherein the roller of the vehicle is designed as two laterally spaced part wheels.

30. The vehicle as claimed in claim 20, wherein the carrying element comprises a cover part, two stand-on parts and a carrying part, wherein the cover part covers the upper part of the ball and the lower part of the ball protrudes downwards out of the carrying part.

31. The vehicle as claimed in claim 20, wherein the ball is driven via two omni-wheels directly and without the interpositioning of a transmission, in each case via an electric motor and each electric motor is fixed to the carrying element.

32. The vehicle as claimed in claim 31, wherein the electric motors are supplied with power via at least one rechargeable battery.

33. The vehicle as claimed in claim 20, wherein the carrying element is supported on the ball via a support arrangement, and wherein the support arrangement comprises at least one non-driven omni-wheel.

34. The vehicle as claimed in claim 20, wherein the vehicle has no handle.
